(19) United States
(12) Patent Application Publication
(10) Pub. No.: US 2026/0273792 A1
(43) Pub. Date: Sep. 17, 2026

(54) SAFE POWER TOOLS

(71) Applicant: CHOMPSHOP, INC., Narberth, PA (US)

(72) Inventors: Kausalya Raman, Honolulu, HI (US); Max Liechty, Narberth, PA (US); Collin Bardini, Folsom, CA (US); William Schultz, Honolulu, HI (US)

(21) Appl. No.: 19/674,865

(22) Filed: May 12, 2026

Related U.S. Application Data
(63) Continuation of application No. 19/400,653, filed on Nov. 25, 2025.
(60) Provisional application No. 63/725,997, filed on Nov. 27, 2024.

(51) Int. Cl. B27C 5/02; B27C 9/00; B27C 9/02

(52) U.S. Cl. CPC B27C 5/02; B27C 9/005; B27C 9/02

(57) ABSTRACT

A power tool for cutting. The power tool has a housing. The housing has a top portion. The top portion defines an opening. A motor assembly is disposed within the housing. A cutting assembly is disposed within the housing and is coupled to the motor assembly. The cutting assembly has a cutting device disposed within the opening. The cutting device includes a shaft having a first end portion and a second end portion oppositely disposed along the longitudinal axis of the cutting device. A cutting portion is coupled to the second end portion of the shaft. The cutting portion has a cutting surface angularly oriented with respect to the longitudinal axis of the cutting device. The motor assembly is configured to drive the cutting device between a first position and a second position in a reciprocating motion to cause the cutting device to cut through a material.

### CROSS-REFERENCE TO RELATED APPLICATION

This application is a continuation of U.S. application Ser. No. 19/400,653, filed Nov. 25, 2025, which is based upon and claims benefit of priority to U.S. Provisional Application No. 63/725,997, filed Nov. 27, 2024, which relates to U.S. Provisional Patent Application No. 63/590,058, filed Oct. 13, 2023, U.S. Provisional Patent Application No. 63/644,251, filed May 8, 2024, and International Application No. PCT/US2024/039748, filed Jul. 26, 2024, which are incorporated herein by reference in their entirety.

### FIELD OF DISCLOSURE

The disclosed systems relate to safe power tools designed to cut through a plurality of materials.

### BACKGROUND

To foster imagination and spatial reasoning, it is important for children to build models of structures and inventions. However, power tools having sharp or rotating parts for cutting materials can be dangerous for kids to use. Thus, these power tools may require direct adult supervision when kids are using the tools. Accordingly, there has been a long felt need for a power tool that is safe for kids to use. The power tools of the present disclosure addresses the shortcomings of conventional power tools and provides a tool kids can use without needing direct adult supervision. The cutting shaft for the power tool of the present disclosure provides a cutting mechanism that can be used safely by kids without needing direct adult supervision.

### SUMMARY

In some embodiments, a power tool may include a housing having a top portion. The top portion may define an opening. The power tool may also include a motor assembly disposed within the housing. The power tool may also include a cutting assembly disposed within the housing and coupled to the motor assembly. The cutting assembly may comprise a cutting device having a longitudinal axis disposed within the opening. The cutting device may comprise a shaft. The shaft may comprise a first end portion and a second end portion oppositely disposed along the longitudinal axis. The cutting device may comprise a cutting portion coupled to the second end portion of the shaft. The cutting portion may comprise a cutting surface angularly oriented with respect to the longitudinal axis. The cutting surface may be configured to engage and cut through a material. The motor assembly may be configured to drive the cutting device between a first position and a second position, which may facilitate cutting through a material.

### BRIEF DESCRIPTION OF THE DRAWINGS

The features and advantages of the present disclosure will be more fully disclosed in, or rendered obvious by, the following detailed descriptions of example embodiments. The detailed descriptions of the example embodiments are to be considered together with the accompanying drawings wherein like numbers refer to like parts and further wherein:

FIG. 1 illustrates an isometric view of one example of a power tool in accordance with some embodiments;

FIG. 2A illustrates an isometric view of one example of a quadrilateral power tool in accordance with some embodiments;

FIG. 2B illustrates an isometric view of one example of a quadrilateral power tool having a grid in accordance with some embodiments;

FIG. 2C illustrates an isometric view of one example of a triangular power tool in accordance with some embodiments;

FIG. 2D illustrates an isometric view of one example of a circular power tool in accordance with some embodiments;

FIG. 3 illustrates an exploded view of one example of a motor assembly and a cutting assembly in accordance with some embodiments;

FIG. 4 illustrates an exploded view of one example of a cutting assembly of a power tool in accordance with some embodiments;

FIG. 5 illustrates an isometric view of one example of a parallel drive motor assembly coupled to a cutting assembly of a power tool in accordance with some embodiments;

FIG. 6 illustrates an isometric view of one example of a gear casing of a power tool in accordance with some embodiments;

FIG. 7 illustrates an isometric view of a debris collection system of one example of a power tool in accordance with some embodiments;

FIG. 8 illustrates an isometric view of one example of a power tool in accordance with some embodiments;

FIG. 9 illustrates an isometric view of the example power tool shown in FIG. 8;

FIG. 10. illustrates an isometric view of at least part of a debris collection system of one example of a power tool in accordance with some embodiments;

FIG. 11 illustrates an isometric view of the example power tool shown in FIG. 8 with the example lid off;

FIG. 12A illustrates an isometric view of the example power tool shown in FIG. 8 with an example cutting guide;

FIG. 12B illustrates an isometric view of the example power tool shown in FIG. 8 with an example cutting guide;

FIG. 12C illustrates an isometric view of the example power tool shown in FIG. 8 with an example cutting guide;

FIG. 12D illustrates an isometric view of an example cutting guide;

FIG. 12E illustrates an isometric view of an example cutting guide;

FIG. 12F illustrates an isometric view of an example hole punch;

FIG. 13 illustrates an isometric view of one example of a shroud of a power tool in accordance with some embodiments;

FIG. 14 illustrates an isometric view of one example of a stabilizer of a power tool in accordance with some embodiments;

FIG. 15A illustrates a first elevational view of an example rod and guard of a power tool in accordance with some embodiments;

FIG. 15B illustrates a second elevational view of the example rod and guard shown in FIG. 15A;

FIG. 15C illustrates a cross-sectional view of the example rod and guard shown in FIG. 15B;

FIG. 16 illustrates an isometric view of an example cutting device;

FIG. 17 illustrates a front view of the example cutting device shown in FIG. 16;

FIG. 18 illustrates a left side view of the example cutting device shown in FIG. 17; and

FIG. 19 illustrates a right side view of the example cutting device shown in FIG. 17.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

This description of the exemplary embodiments is intended to be read in connection with the accompanying drawings, which are to be considered part of the entire written description. It should be understood, however, that the present disclosure is not intended to be limited to the particular forms disclosed and that the drawings are not necessarily shown to scale. Rather, the present disclosure covers all modifications, equivalents, and alternatives that fall within the spirit and scope of these exemplary embodiments. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The terms “couple,” “coupled,” “operatively coupled,” “operatively connected,” and the like should be broadly understood to refer to connecting devices or components together either mechanically, or otherwise, such that the connection allows the pertinent devices or components to operate with each other as intended by virtue of that relationship.

The disclosed devices and systems may enable safe cutting through a material. Use of the devices and systems disclosed herein will continue to foster science, technology, engineering, and mathematics (STEM) education by allowing kids to build prototypes of their own without direct adult supervision.

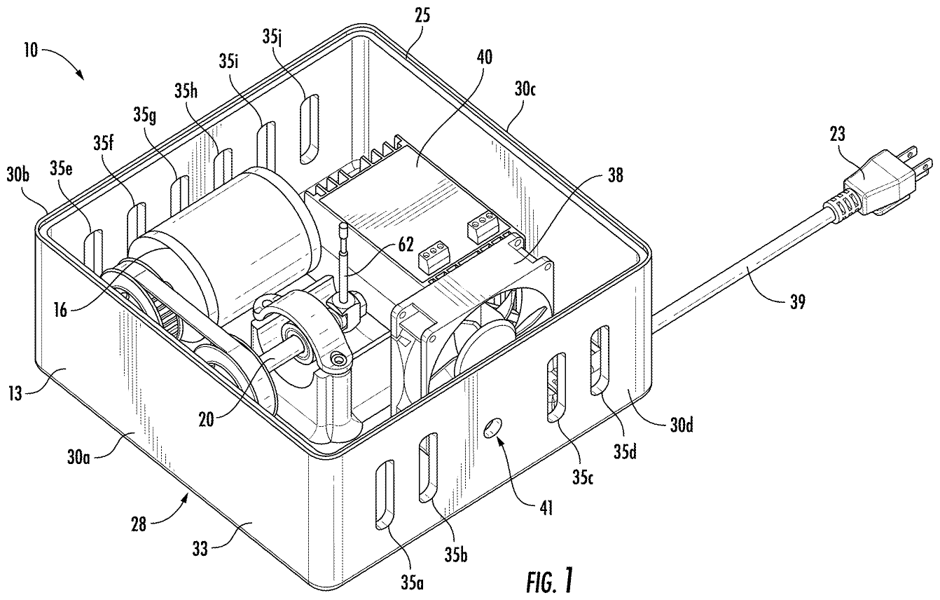

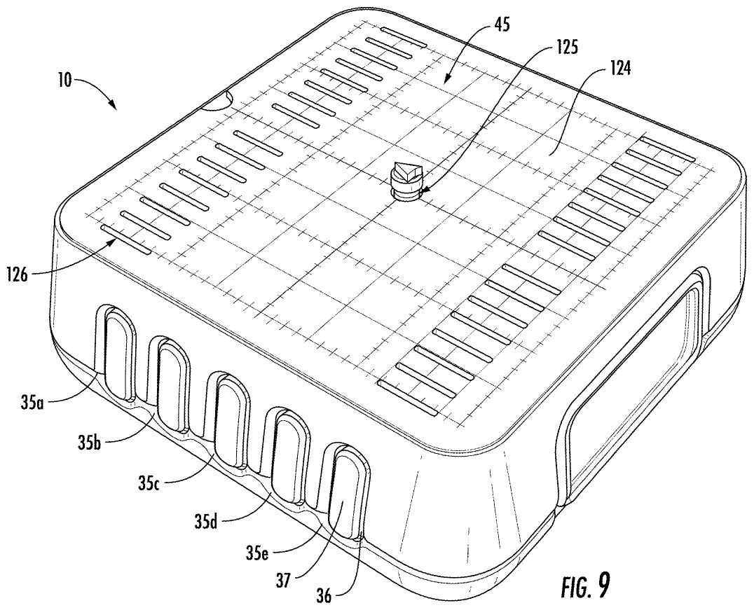

Referring now to the figures, FIG. 1 illustrates isometric view of one example of a power tool 10 in accordance with some embodiments. Power tool 10 may include a housing 13, a motor assembly 16, a cutting assembly 20, and a power source 23. Housing 13 of power tool 10 may have a top portion 25 and a bottom portion 28. Bottom portion 28 may comprise at least one depression or recess to allow a tool 10 to be stacked on top of another tool 10. Housing 13 may also have a plurality of sides 30a-d. Top portion 25, bottom portion 28, and sides 30a-d may be coupled together so as to enclose the internal components (e.g., motor assembly 16, cutting assembly 20, etc.) of power tool 10. In some embodiments, housing 13 may be formed in individual pieces. In other embodiments, housing 13 may be formed in two or more pieces. For example, the base 33 of housing 13 may be formed as one piece, including sides 30a-d and bottom portion 28. Top portion 25 may then be a separate piece acting as a “lid”, providing access to the internal components of power tool 10 for maintenance and repair. The housing 13 may include one or more switches that disable electronics, including at least the motor, when the housing 13 is disassembled. For example, the switch may disable the electronics if the top portion 25 and bottom portion 28 are disassembled. Optionally, as shown in FIG. 11, the top portion 25 may comprise a recess 120. The recess 120 may be configured to receive and store accessories, a power cord, and/or a plug. The top portion 25 may comprise a depressed portion 122 configured to receive and secure a lid 124 as described herein. Optionally, the lid 124 may comprise one or more cutouts 123. The top portion 25 may comprise at least one depression or dimple 121 having a location corresponding to at least one of the one or more cutouts 123 in the lid. The cutouts 123 and/or dimples 121 provide access to easily remove, flip, and/or rotate the lid 124 with respect to the top portion 25.

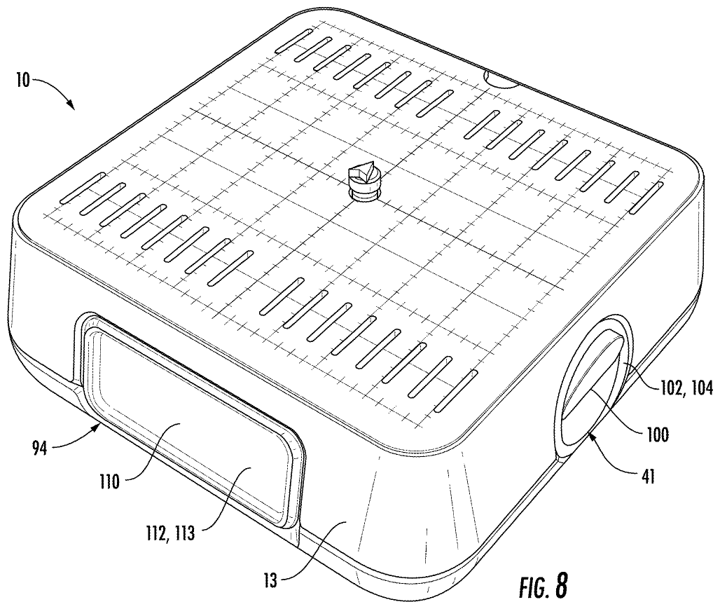

In some embodiments, sides 30a-d may define one or more ports 35a-j disposed through sides 30a-d. Ports 35a-j may be configured to provide ventilation to the internal components of power tool 10 during use. As shown in FIG. 9, each port of the one or more ports 35a-j may comprise a slotted vent 36. Optionally, the slotted vent 36 may include a cap 37 configured to allow airflow to cool the internal components while preventing exterior access to the tool 10 interior. As shown in FIG. 1, power tool 10 may also include a cooling element 38 disposed within housing 13 to provide cooling to the internal components. Cooling element 38 may include a fan, or other cooling system (e.g., coolant, water, lubricant, etc.).

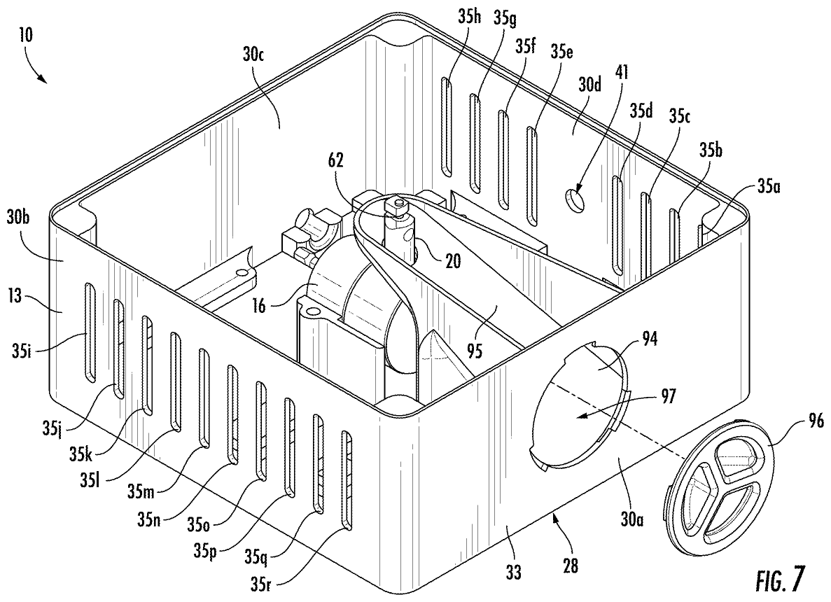

Power source 23 of power tool 10 may rely on alternating current (AC) power from a wall outlet through power cord 39. In this example, AC power may be converted to direct current (DC) power through an AC to DC converter 40. The converter 40 may be positioned within the housing 13. The converter 40 may be positioned on the exterior to the housing 13. However, in other embodiments, power tool 10 may be powered directly from AC power if the motor assembly 16 is configured for AC voltage. In some embodiments, power tool 10 may include one or more batteries (not shown) to provide power to the motor assembly 16 instead of or in addition to an AC power source 23. As shown in FIG. 8, power tool 10 may include a power switch 100 disposed within aperture 41 of housing 13. Power switch 100 disposed within aperture 41 may be configured to turn on and off power tool 10 when power cord 39 is plugged in or when power tool 10 is being powered by one or more batteries. Power tool 10 may also include status indicators through lights and/or a display. For example, as shown in FIG. 8, a status indicator 102 may comprise a light 104. Optionally, the light 104 may be an LED ring encircling the power switch 100. The status indicator 102, in this example the light 104, may indicate “Power Available” if the power tool is plugged in or not. For example, the light 104 may light up (for example white or yellow light) if power is available. Still further, the light 104 may change colors or blink to indicate other operations or errors. For example, the light 104 may change to green when the power switch 100 is switched on and the light 104 may change to red to indicate the tool 10 is overheated, jammed, or disassembled. One of ordinary skill in the art will appreciate the plurality of different status indicators that may be useful to include with power tool 10.

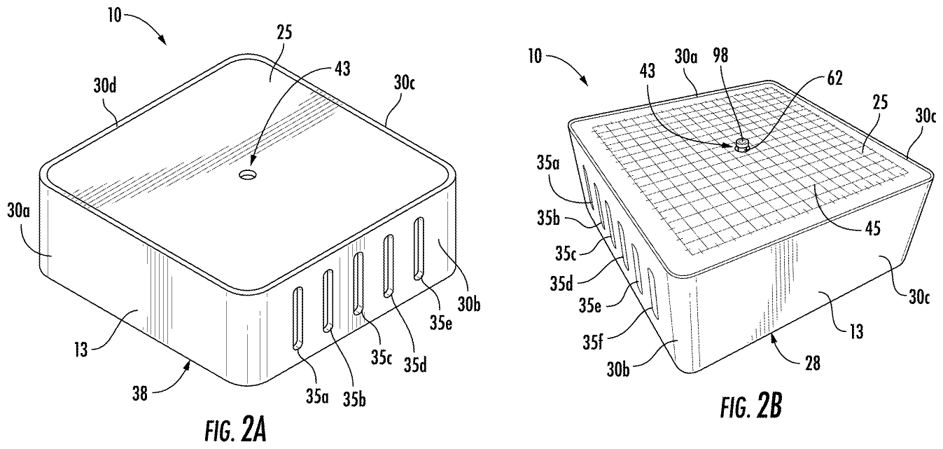

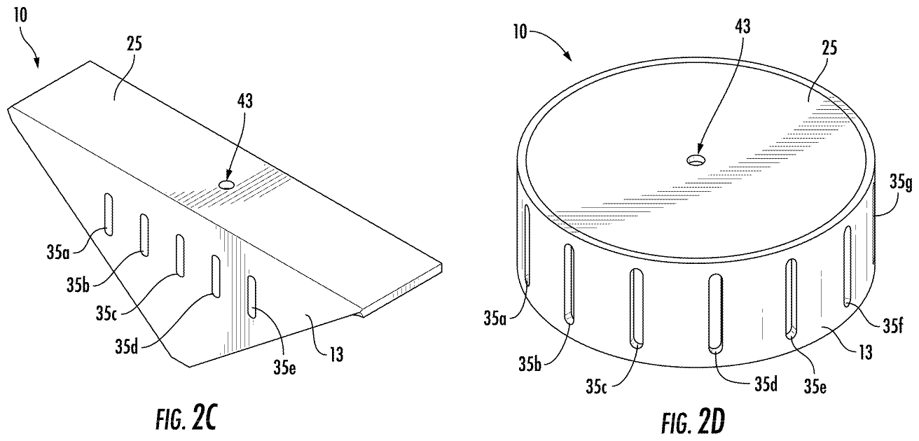

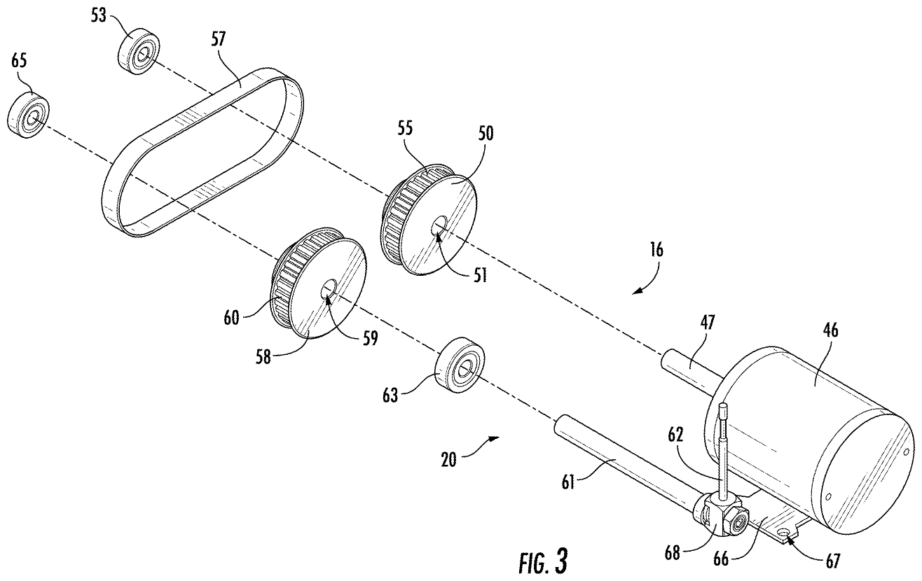

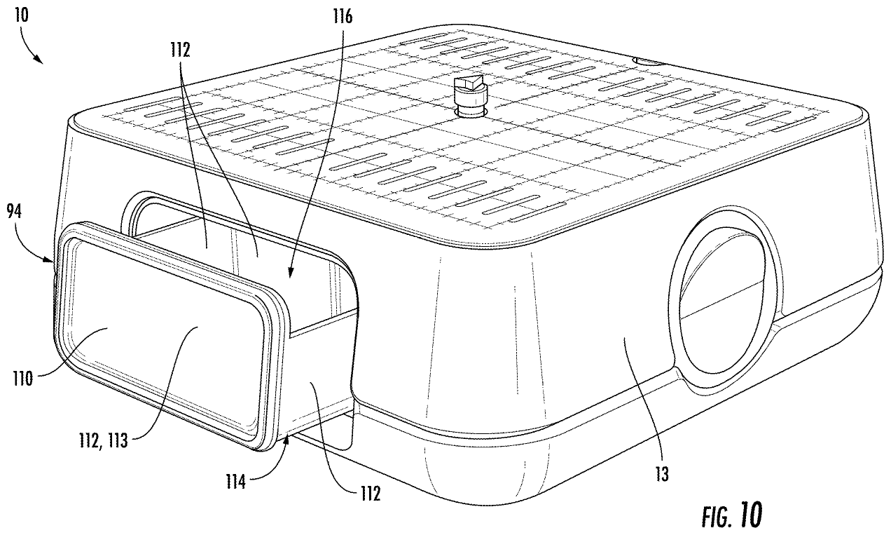

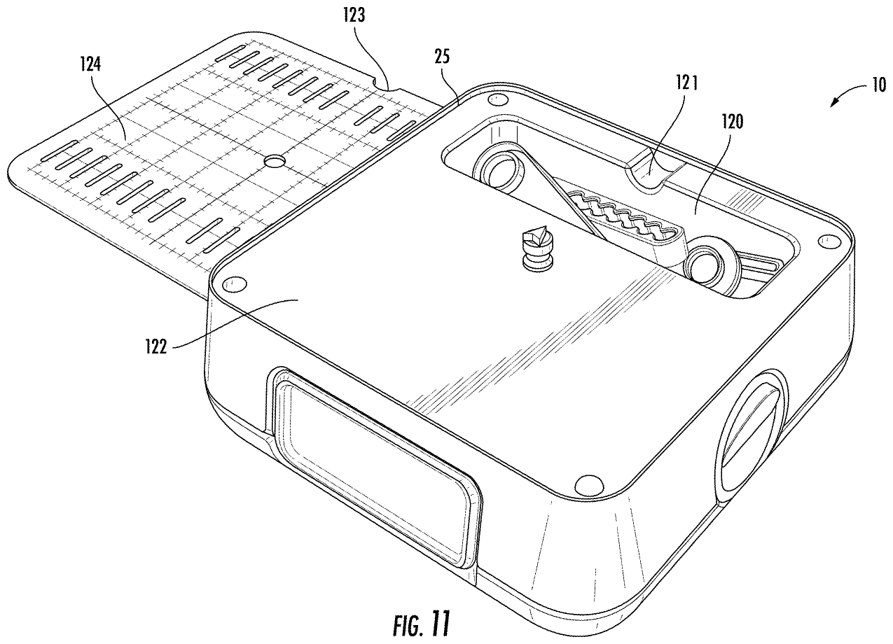

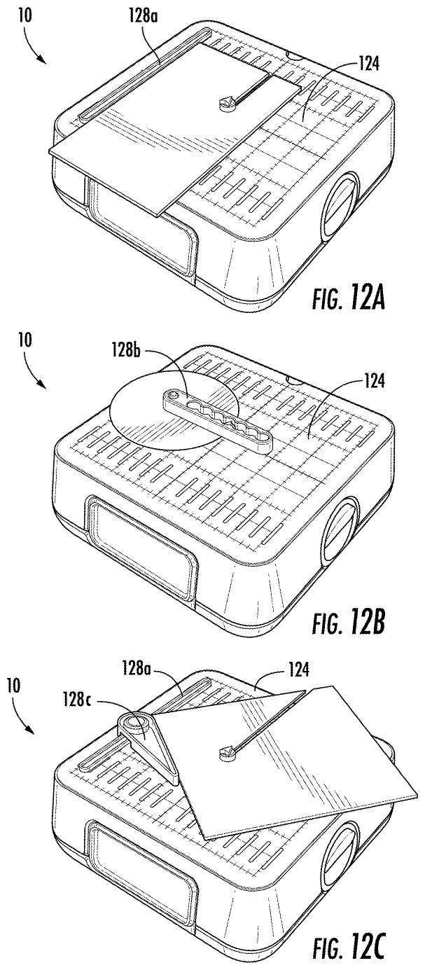

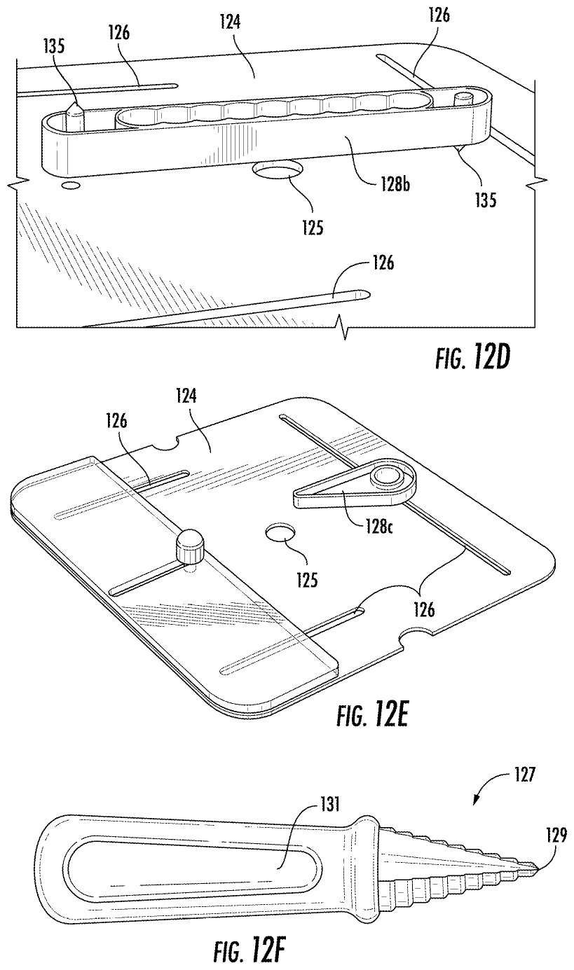

FIGS. 2A-2D illustrate various shapes of a power tool 10 in accordance with some embodiments. As illustrated in FIGS. 2A-2B, housing 13 of power tool 10 may be a quadrilateral (e.g., square, rectangle, rhombus, etc.) shape. In other embodiments, housing 13 may be triangular as illustrated in FIG. 2C or circular as illustrated in FIG. 2D. One of ordinary skill in the art will appreciate that housing 13 may be one of a plurality of shapes and the examples disclosed herein are not limiting. Top portion 25 may define one or more openings 43 each sized and configured to receive a cutting member of cutting assembly 20, discussed in more detail below. Opening 43 is illustrated as a circular hole, but could be an elongate slot or some other configuration. Top portion 25 may also include a grid 45 design with size (e.g., length and width) markings along the grid 45. Optionally, as shown in FIG. 9, a lid 124 positionable on the top portion 25 may comprise the grid 45 design and may define one or more openings 125 each sized and configured to receive a cutting member of cutting assembly 20. Optionally, the top portion 25 and/or the lid 124 may comprise one or more slots 126. Each slot of the one or more slots 126 may be configured to receive and secure a cutting guide 128a-128c (shown in FIGS. 12A-12E). Optionally, each slot 126 may be sized and positioned to receive any of the cutting guides 128a-128c. Alternatively, each slot 126 may be sized and positioned to receive a designated cutting guide. For example, one slot 126 may be configured to receive a first cutting guide while another slot 126 may be configured to receive a second cutting guide that is different than the first cutting guide. FIGS. 12A-12C show exemplary accessories including, for example, cutting guides 128a-128c. The cutting guides 128a-128c may be used to guide straight cutting (shown in FIG. 12A), circular cutting (shown in FIGS. 12B and 12D), and angled cutting (shown in FIGS. 12C and 12E). The straight cutting guide 128a and the angled cutting guide 128c may be configured to slide along one or more slots. Optionally, the guides 128a-128c may be held in position with one or more fastener such as, for example, a set screw, thumb screw, or clamping lever. The angled cutting guide 128c may attach to another guide, for example a straight cutting guide 128a, as illustrated in FIG. 12C or may attach directly to the lid 124 or top portion via a slot 126 as illustrated in FIG. 12E. The angled cutting guide 128c may comprise a ribbed surface to lock the guide at a specific angle. Optionally, the angled cutting guide 128c may comprise a spring-loaded detent or a screw type fastener to set the angle. The circular cutting guide 128b may include a plurality of openings that fit around a guard 98 (described in more detail herein). The circular guide 128b may have a first side including openings that fit around a guard 98 and spaced on an imperial scale and a second side including openings that fit around a guard 98 and spaced on a metric scale. The circular guide 128b may comprise at least one pin 135 protruding from the bottom and/or top surface of the guide 128b to hold the material, for example cardboard, in place at a determined distance from the guard 98 and cutting member. The pin 135 may be positioned at the center of rotation of the material and may define the radius of the cut. Optionally, the one or more slots 126 may have a width configured to receive and secure a thickness of a specified material, such as cardboard, thereby allowing custom cutting guides constructed from the specified material, such as cardboard, to be made and used. As shown in FIG. 12F, accessories for the tool 10 may include a hole punch 127. The hole punch 127 may comprise a body 131 which has an end that tapers to a tip 129 configured to punch a hole in a specified material such as cardboard. The hole punch 127 may allow a user to puncture a hole in the specified material. The shape and size of the hole may correspond to the guard 98 thereby allowing the material to be placed on the lid 124 or top portion 25 with the guard 98 and cutting member extending through the punctured hole to allow a cut to begin from the hole. Optionally, the tapered end of the hole punch 127 may comprise a step design wherein different portions of the taper are defined between edges. Each portion may have a different diameter to allow a user to use the hole punch 127 to create holes having different diameters.

FIG. 3 illustrates an exploded view of one example of a motor assembly 16 and a cutting assembly 20. Motor assembly 16 of power tool 10 comprises a motor 46. The motor 46 may be configured to drive the cutting assembly 20. The motor assembly 16 may further include a drive shaft 47, a motor gear or pulley 50, and a first bearing 53. Motor 46 may be any one of an AC or DC motor and may be powered through any one of the power sources discussed above. Drive shaft 47 may be driven by motor 46 and may be a metal or metal alloy material. In some embodiments, drive shaft 47 may be made of other materials such as a plastic material. Motor gear 50 may be substantially circular and may define a slot 51 through motor gear 50. Drive shaft 47 may be sized and shaped to be received in slot 51 of motor gear 50. Motor gear 50 may include a plurality of teeth 55 configured engage a belt 57. It will be appreciated that motor gear 50 may not include teeth 55 in some embodiments. In some embodiments, belt 57 may also include respective ridges (not shown) that are configured to interact with teeth 55. In some embodiments, belt 57 may be an elastic material, such as rubber or other elastomer.

Cutting assembly 20 may include a cutting gear 58, a cam shaft 61, a cutting member 62, a second bearing 63, and a third bearing 65. Cutting gear 58 may be substantially circular and may define a slot 59 through cutting gear 58. Cutting gear 58 may include teeth 60 configured to engage belt 57. Cam shaft 61 may be sized and shaped to be received in slot 59 of cutting gear 58. Cam shaft 61 may be coupled to cutting gear 58 and cutting member 62. Cam shaft 61 may be any one of a metal, metal alloy, or plastic material. Cutting assembly 20 may be coupled to motor assembly 16 through belt 57. In some embodiments, motor assembly 16 and/or cutting assembly 20 may be secured to the inside of power tool 10 through a bracket 66, which defines at least one void 67. Void 67 may be sized and shaped to receive a fastener, such as a screw or bolt. Optionally, the void 67 may receive at least one vibration dampener to reduce noise. In some embodiments, first bearing 53, second bearing 63, and third bearing 65 may be mounted to a side 30a-d of housing 13 or otherwise secured within housing 13 so that drive shaft 47 and cam shaft 61 are aligned and do not wobble.

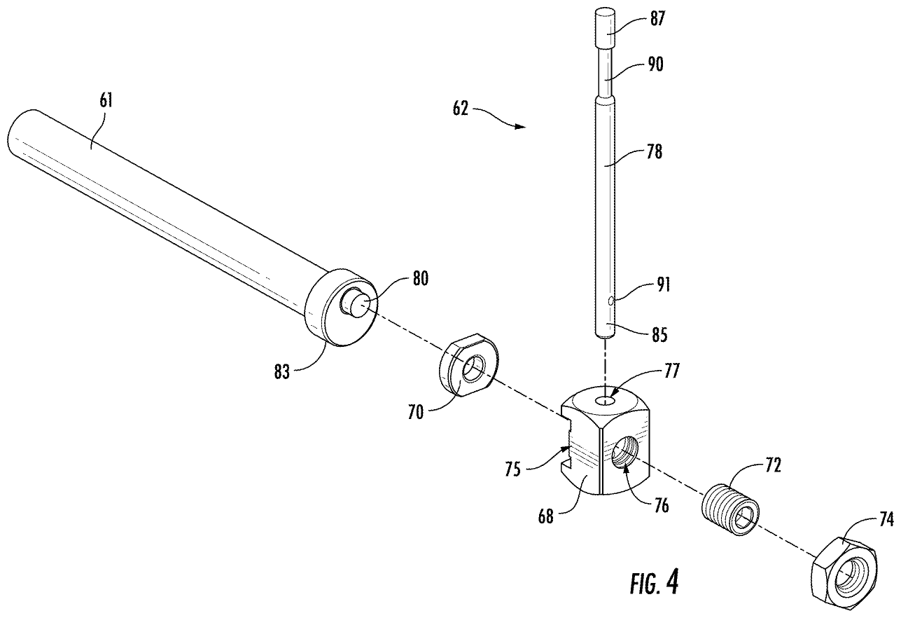

FIG. 4 illustrates an exploded view of one example of a cutting assembly 20. Cutting member 62 may include an adapter 68, washer 70, set screw 72, nut 74, and rod 78. Adapter 68 may define a groove 75 configured to receive washer 70. Adapter 68 may also define a hole 76 sized and shaped to receive a threaded set screw 72. Adapter 68 may further define a void 77 sized and configured to receive a portion of rod 78. Cam shaft 61 may include a pin 80 disposed on and/or extending from a first end 83 of cam shaft 61. Washer 70 may be sized and shaped to receive pin 80, such as by defining an aperture. Pin 80 may be configured to convert a rotational motion of cam shaft 61 to a reciprocating motion of rod 78 through washer 70 and adapter 68.

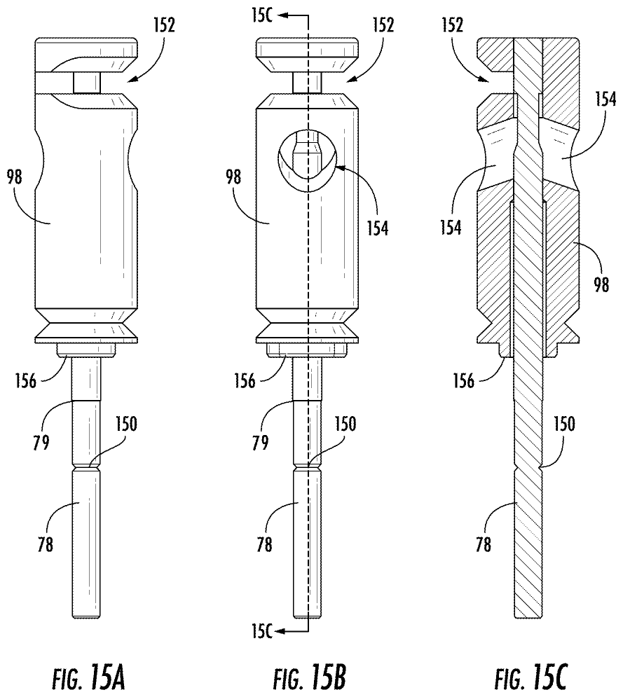

Rod 78 may be disposed between a first end 85 and a second end 87. Rod 78 may define a groove 90 near second end 87. Rod 78 may be sized and shaped to fit within opening 43 defined by top portion 25. Although rod 78 is illustrated as a blunt object, it will be appreciated that rod 78 may have one or more sharp edges or surfaces to cut through a material and/or may have a pointed edge to punch through a material. Rod 78 may also define a divot 91 near first end 85. The divot 91 may be sized and shaped to receive set screw 72. For example, divot 91 may be threaded and configured to receive a threaded set screw 72. Alternatively, as shown in FIGS. 15A-15C, the rod 78 may comprise an indentation 150 sized and positioned to receive the set screw 72. The indentation150 may extend around the circumference of the rod 78. The rod 78 is secured to the adapter 68 through set screw 72 and nut 74 so that the rotating motion of cam shaft 61 is transferred to reciprocating motion of rod 78 through adapter 68. As shown in FIGS. 15A-15C, rod 78 may comprise a lip 79 having a diameter larger than the diameter of the void 77 in the adapter to allow easy depth alignment of the rod 78 and the adapter 68.

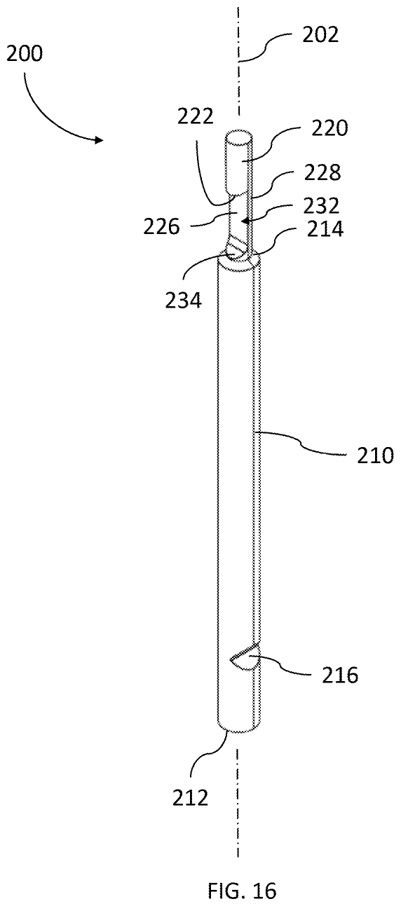

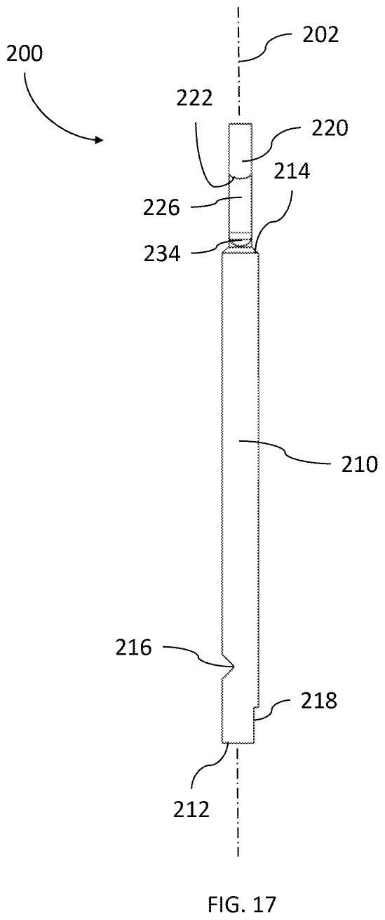

FIGS. 16-19 show an example cutting device 200. The cutting device 200 is an example embodiment of a rod 78. The cutting device 200 has a longitudinal axis 202. The cutting device 200 comprises a shaft 210. The shaft 210 comprises a first end portion 212 and a second end portion 214 oppositely disposed along the longitudinal axis 202. The shaft 210 may comprise an indentation 216 positioned between the first end 212 and the second end 214. The indentation 216 may be configured to engage a locking component, for example set screw 72, of the cutting assembly 20. As shown in FIG. 17, the indentation 216 may be a “V” shaped notch. Optionally, the indentation 216 is positioned closer to the first end portion 212 than to the second end portion 214. The shaft 210 may comprise a notch 218. The notch 218 may abut the first end portion 212. The notch 218 may be configured to insert into a corresponding receiving space in the adapter 68 of the cutting assembly 20. The notch 218 may align the cutting device 200 in the adapter thereby properly aligning the cutting device 200 with respect to other cutting assembly 20 components and other power tool components. The notch 218 may indicate the correct orientation of the cutting device 200 to a user.

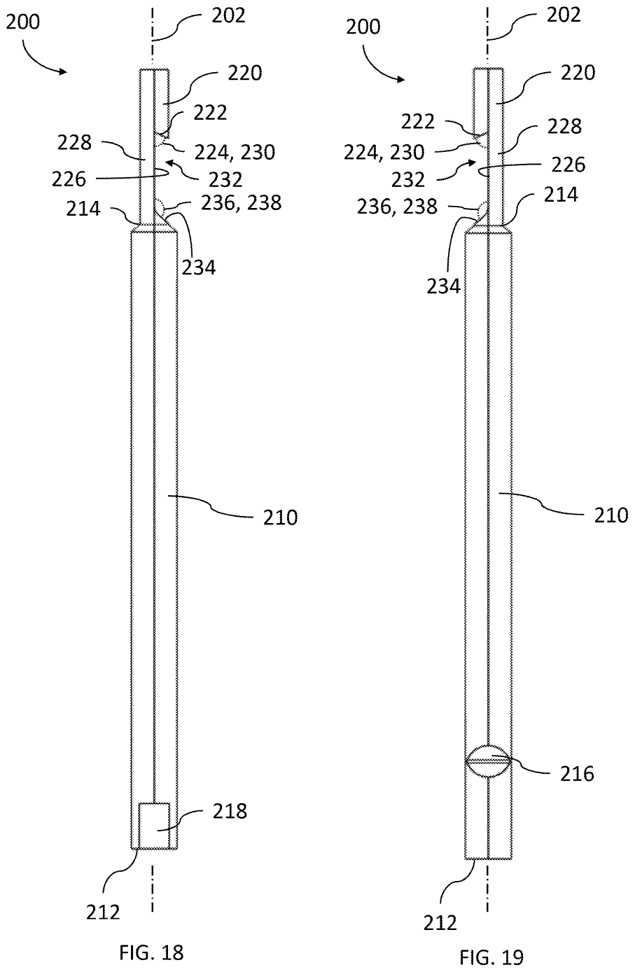

The cutting device 200 comprises a cutting portion 220 coupled to the second end portion 214 of the shaft 210. The cutting portion 220 comprises a cutting surface 222 configured to engage and cut through material, for example cardboard, paper, or foam. The cutting surface 222 is angularly oriented with respect to the longitudinal axis 202. As shown in FIGS. 18 and 19, optionally, an angle 224 of the cutting surface 222 is between 0 and 90° with respect to the longitudinal axis. Optionally, the angle 224 is between 10° and 80° with respect to the longitudinal axis. Optionally, the angle 224 is between 20° and 70° with respect to the longitudinal axis. Optionally, the angle 224 is between 30° and 60° with respect to the longitudinal axis. The cutting surface 222 may extend outwardly with respect to the longitudinal axis 202 (optionally radially outwardly) from a first portion 226 of an exterior surface 228 of the cutting portion 220. Optionally, an angle 230 extending from the cutting surface 222 to the first portion 226 of the exterior surface 228 is between 0 and 90°. Optionally, the angle 230 is between 10° and 80°. Optionally, the angle 230 is between 20° and 70°. Optionally, the angle 230 is between 30° and 60°. The angular orientation of the cutting surface 222 with respect to the longitudinal axis 202 and the first portion 226 of the exterior surface 228 may improve the lifespan of the cutting device 200 and may decrease resistance from the material being cut. The first portion 226 of the exterior surface 228 may extend along the longitudinal axis 202. The first portion 226 of the exterior surface 226 may extend along a plane parallel or substantially parallel (for example within 10° of parallel) to the longitudinal axis 202.

The cutting surface 222 and the first portion 226 of the exterior surface 228 may define at least a portion of a recess 232 within the cutting portion 220. Optionally, the cutting surface 222, the first portion 226 of the exterior surface 228, and a second portion 234 of the exterior surface 228 of the cutting portion 220 may define the recess 232. The second portion 234 of the exterior surface 228 may extend outwardly with respect to the longitudinal axis 202 (optionally radially outwardly) from the first portion 226 of the exterior surface 228. The first portion 226 of the exterior surface 228 of the cutting portion 220 may be contiguous with and positioned between the cutting surface 222 and the second portion 234 of the exterior surface 228. Optionally, the second portion 234 of the exterior surface 228 is parallel or substantially parallel (for example within 10° of parallel) to the cutting surface 222. An angle 236 extending from the second portion 234 of the exterior surface 228 to the first portion 226 of the exterior surface 228 may be between 90° and 180°. Optionally, the angle 236 is between 100° and 170°. Optionally, the angle 236 is between 110° and 160°. Optionally, the angle 236 is between 120° and 160°. The second portion 234 of the exterior surface 228 may be angularly oriented with respect to the longitudinal axis 202. Optionally, an angle 238 of the second portion 234 of the exterior surface 228 may be between 90°and 180°with respect to the longitudinal axis 202. Optionally, the angle 238 is between 100° and 170° with respect to the longitudinal axis 202. Optionally, the angle 238 is between 110° and 160° with respect to the longitudinal axis 202. Optionally, the angle 238 is between 120° and 160° with respect to the longitudinal axis 202. The angular orientation of the second portion 234 of the exterior surface 228 with respect to the longitudinal axis 202 and the first portion 226 of the exterior surface 228 may improve manufacturability.

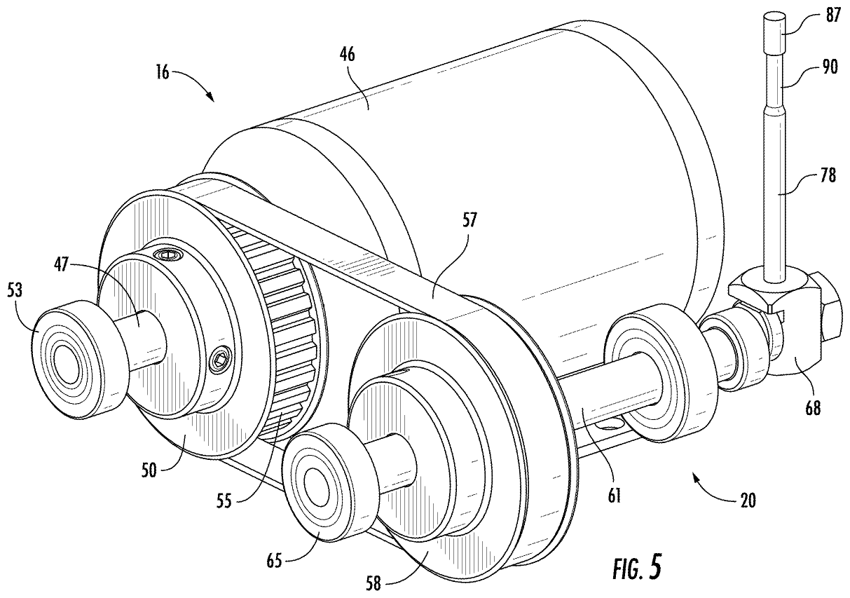

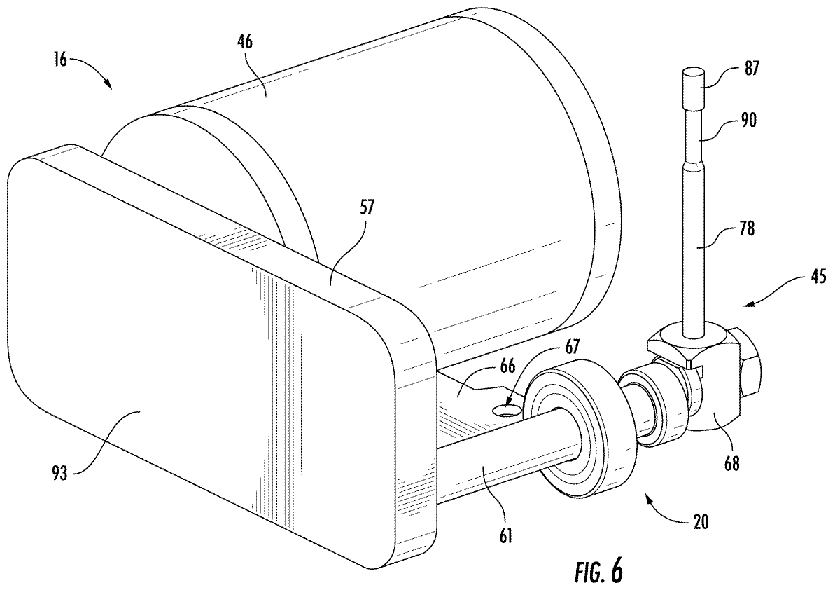

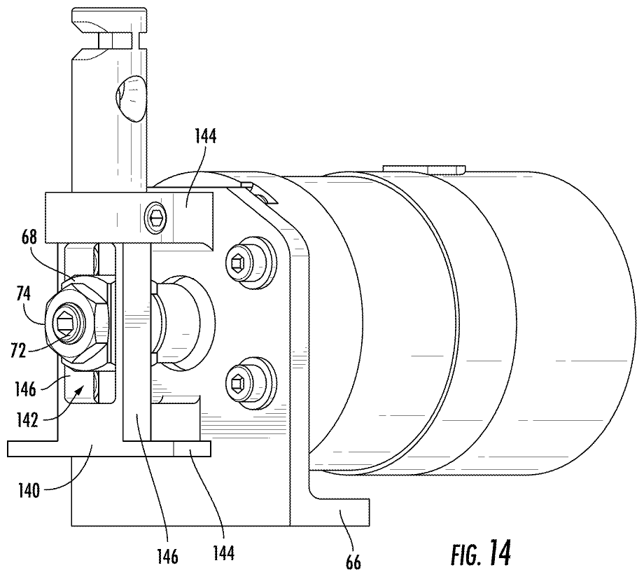

FIGS. 5-6 illustrate an isometric view of one example of a parallel drive motor assembly 16 coupled to cutting assembly 20 of power tool 10 in accordance with some embodiments. Operation of motor 46 drives rod 78 in a reciprocating motion such that the one or more edges or surfaces (e.g., cutting surface 222) of rod 78 will cut or “nibble” away at a material when the material is contacted by the edges or surfaces of rod 78. For example, as motor 46 turns belt 57 through drive shaft 47 and motor gear 50, belt 57 also turns cutting gear 58 and cam shaft 61 through a parallel drive system. Rotation of cam shaft 61 facilitates reciprocating movement of rod 78 between a first position (e.g., up) and a second position (e.g., down). Optionally, as shown in FIG. 14, the tool 10 may comprise a stabilizer 140 to secure the adapter 68, and therefore, the rod 78, to the housing to reduce or prevent horizontal movement or vibration which may cause excess heat, noise, wear and/or damage the tool 10. FIG. 14 shows an example stabilizer 140 comprising one or more connecting members 144 configured to connect the stabilizer 140 directly or indirectly to the housing. For example, as shown in FIG. 14, the connecting members 144 may be configured to connect the stabilizer 140 to bracket 66. The stabilizer 140 may further comprise vertical members 146 coupled to the connecting members 144. Vertical members 146 may be spaced apart from each other to define an adapter receiving space 142. Space 142 may be sized to receive the adapter 68 and allow the adapter 68 to move up and down while preventing the adapter 68 from moving horizontally. Optionally, the vertical members 146 may have slots and the adapter may have corresponding bosses that are configured to be received by the slots or vice versa to the allow the adapter 68 to move up and down while preventing the adapter 68 from moving in other directions.

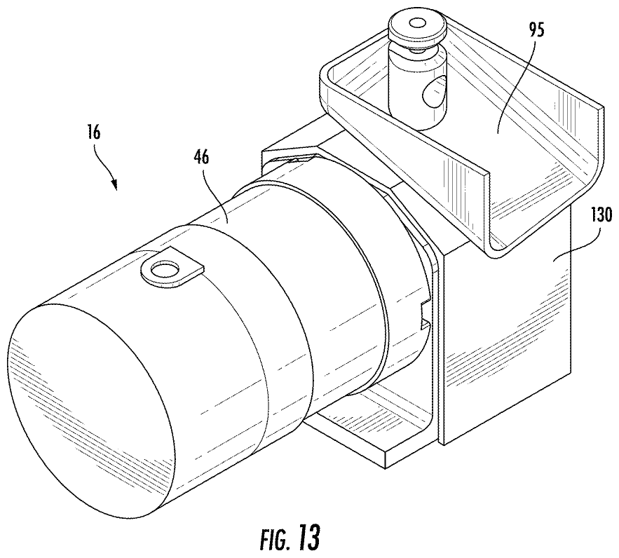

In some embodiments, power tool 10 may include a gear casing 93, shown in FIG. 6, or shroud 130, shown in FIG. 13, that is configured to enclose moving components, such as motor gear 50 and cutting gear 58. Gear casing 93 or shroud 130 may be used to restrict access to additional moving parts while motor 46 is in operation. For example, gear casing 93 or shroud 130 may be used to cover the rotating gears 50, 58 and belt 57 during maintenance of power tool 10. Further, the gear casing 93 or shroud 130 may protect the moving components from debris. Although motor 46 has been described above as driving belt 57, it will be appreciated that pulleys, a parallel gearbox, or any other parallel drive system that is able to provide the necessary torque and revolutions per minute (RPM) to drive rod 78 may be used.

FIG. 7 illustrates a debris collection system 94 of one example of a power tool 10 in accordance with some embodiments. Debris collection system 94 may include a ramp 95 and a door 96. The ramp 95 may be configured to receive any material debris caused by the cutting of material by cutting member 62. For example, the ramp 95 may have rails on either side of the ramp 95 so that any debris is received within ramp 95 and collects against a side 30a of housing 13. As shown in FIG. 13, the ramp 95 may be coupled to or integral with the gear casing 93 or shroud 130. Housing 13 may define an opening 97 configured to receive door 96 so that a user can easily access the collected debris on ramp 95. Although door 96 and opening 97 are illustrated as being circular in shape, one will appreciate that door 96 and opening 97 may be any suitable size and shape to access the debris collected within housing 13. For example, opening 97 may be of a suitable size and shape to receive a hose or attachment of a vacuum used to remove the debris from housing 13. With reference to FIG. 8 and FIG. 10, the debris collection system 94 may comprise a drawer 110. As shown in FIG. 10, the drawer 110 may comprise a plurality of side panels 112 and a bottom panel 114 defining a collection space 116 configured to contain debris, such as dust. Optionally, the drawer 110, specifically the collection space 116, may be positioned to collect debris moved through the ramp 95. The drawer 110 may slide in and out of the housing 13 so that the drawer 110 may be opened or removed to dispose of the collected debris. As shown in FIG. 8, in a closed position wherein the collection space 116 is positioned to collect debris, one 113 of the side panels 112 may abut the housing 13 to contain the debris within the housing until the drawer 110 is opened and/or removed to dispose of the debris. Further, the tool 10 may comprise a switch or sensor (e.g., proximity sensor) that may be activated when the drawer 110 is correctly and fully inserted into the housing 13 and deactivated when the drawer 110 is opened or removed from the housing 13. Optionally, the sensor may detect when the drawer or cavity contains a certain amount of debris to signal that the drawer or cavity should be emptied. The switch may disable the motor, and therefore, the cutting element, when the switch is deactivated. Similarly, when a sensor is used, the sensor can be communicatively coupled to a microprocessor (or other processing unit) that disables the motor, and therefore, the cutting element, when the sensor is deactivated (e.g., not detecting a presence of the drawer 110 within the housing 13). Optionally, the fan or cooling element 38 may remain running regardless of the switch or sensor being activated or deactivated. For example, when the drawer 110 is opened and/or removed, the moving components cannot move to ensure safety as there may be access to the moving components when the drawer 110 is removed. The motor, and therefore, the cutting elements may resume motion when the drawer 110 is reinserted in the housing 13 and the switch or sensor is activated.

Referring back to FIGS. 1-2D, rod 78 may be configured to be received through opening 43. Groove 90 or recess 232 of rod 78 may be configured to move up through opening 43 and back down through opening 43 in a reciprocating motion. As illustrated in FIG. 2B and FIGS. 15A-15C, second end 87 of rod 78 includes a guard 98. Guard 98 may be sized and shaped to receive rod 78. Optionally, the guard 98 may allow motion of rod 78 through guard 98. The guard may comprise a slot 152 therein, configured to receive material to be cut, for example cardboard. The slot 152 may have a thickness that allows the material to engage the cutting member, the groove of the rod in this example, and prevents a user from accessing the cutting member thereby preventing accidental injury. Guard 98 may be configured so that fingers of a user do not get caught within groove 90 or recess 232, which could injure the user if motor 46 was in operation. In some embodiments, the gap between the guard 98 and the top portion 25 may be as little as 3-4 millimeters in width, although one of ordinary skill in the art will understand that the width of the gap may have other dimensions. For example, the gap may be sized to prevent a finger of a user from getting caught during operation. Advantageously, the size of the gap allows kids to use the power tool 10 without direct adult supervision. As shown in FIGS. 15A-15C, the guard 98 may comprise a key 156 which may be designed to fit into opening 43 in the top portion 25 or an opening in the gear casing 93, shroud 130, stabilizer 140 and/or ramp 95 to help secure the cutting member in the opening 43. For example, the key 156 may comprise a protrusion extending from the bottom surface of the guard 98 that is a size and shape that securely fits within the opening 43 (e.g., by friction fit). Optionally, in an example embodiment, the guard 98 may comprise at least one opening 154 to allow debris to exit the guard 98. Optionally, the guard 98 may comprise a mark to signal the direction of cutting.

Reciprocating motion of groove 90 or recess 232 facilitates a cutting, or “nibbling”, action of a material when introduced into the groove 90 of the rod 78 when the motor 46 is in operation. The material may be any cuttable material that fits within the gap between the guard 98 and top portion 25. The material may be any one of a fabric, cardboard, plastic, metal, or any combination thereof. For example, cardboard may be introduced into groove 90 while motor 46 is in operation. When groove 90 moves down through opening 43, the cardboard is pinched between the groove 90, guard 98, and top portion 25. Rapid reciprocation of rod 78 facilitates quick and seamless cutting or nibbling action of the cardboard. Optionally, the cutting rod 78 and the gap may be substantially similar or equal in dimensions such that the cut width is substantially similar or equal to the thickness of the material, enabling the slotting of pieces together to build 3D shapes. As an example, power tool 10 may be used by kids to cut out different shapes in a cardboard material. These shapes may then be used to build models of any desired structure or invention. In some embodiments, power tool 10 may be included in a kit with an instruction manual of different models to make.

It may be emphasized that the above-described embodiments, particularly any “preferred” embodiments, are merely possible examples of implementations, set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

While this specification contains many specifics, these should not be construed as limitations on the scope of any disclosures, but rather as descriptions of features that may be specific to particular embodiment. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

### EXEMPLARY ASPECTS

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.
Aspect 1: A cutting device having a longitudinal axis for use with a power tool, the cutting device comprising:
   a shaft comprising a first end portion and a second end portion oppositely disposed along the longitudinal axis; and
   a cutting portion coupled to the second end portion of the shaft, the cutting portion comprising a cutting surface angularly oriented with respect to the longitudinal axis, the cutting surface configured to engage and cut through a material.
Aspect 2: The cutting device according to aspect 1, wherein the angular orientation of the cutting surface is between 10° and 60° with respect to the longitudinal axis.
Aspect 3: The cutting device according to aspect 1 or aspect 2, wherein the cutting surface extends outwardly with respect to the longitudinal axis from a first portion of an exterior surface of the cutting portion.
Aspect 4: The cutting device according to aspect 3, wherein an angle extending from the cutting surface to the first portion of the exterior surface is between 10° and 60°.
Aspect 5: The cutting device according to aspect 3 or aspect 4, wherein the first portion of the exterior surface of the cutting portion extends along the longitudinal axis.
Aspect 6: The cutting device according to any of aspects 3-5, wherein the first portion of the exterior surface extends along a plane substantially parallel to the longitudinal axis.
Aspect 7: The cutting device according to any of aspects 3-6, wherein the cutting surfaces extends radially outwardly from the first portion of the exterior surface.
Aspect 8: The cutting device according to any of aspects 3-7, wherein the cutting surface and the first portion of the exterior surface of the cutting portion define at least a portion of a recess within the cutting portion.
Aspect 9: The cutting device according to aspect 8, wherein the cutting surface, the first portion of the exterior surface of the cutting portion, and a second portion of the exterior surface of the cutting portion define the recess, wherein the second portion of the exterior surface of the cutting portion extends outwardly with respect to the longitudinal axis from the first portion of the exterior surface of the cutting portion.
Aspect 10: The cutting device according to aspect 9, wherein the first portion of the exterior surface of the cutting portion is contiguous with and positioned between the cutting surface and the second portion of the exterior surface of the cutting portion.
Aspect 11: The cutting device according to aspect 9 or aspect 10, wherein the second portion of the exterior surface of the cutting portion extends radially outwardly from the first portion of the exterior surface.
Aspect 12: The cutting device according to any of aspects 9-11, wherein the second portion of the exterior surface of the cutting portion is substantially parallel to the cutting surface.
Aspect 13: The cutting device according to any of aspects 9-12, wherein an angle extending from the second portion of the exterior surface of the cutting portion to the first portion of the exterior surface is between 100° and 150°.
Aspect 14: The cutting device according to any of aspects 9-13, wherein the second portion of the exterior surface of the cutting portion is angularly oriented with respect to the longitudinal axis.
Aspect 15: The cutting device according to aspect 14, wherein the angular orientation of the second portion of the exterior surface of the cutting portion is between 100° and 150° with respect to the longitudinal axis
Aspect 16: The cutting device according to any of the preceding aspects, wherein the shaft further comprises an indentation positioned between the first end portion and the second end portion, the indentation configured to engage a locking component of a cutting assembly of the power tool.
Aspect 17: The cutting device according to aspect 16, wherein the indentation is positioned closer to the first end portion than the second end portion.
Aspect 18: The cutting device according to any of the preceding aspects, wherein the shaft further comprises a notch abutting said first end portion, the notch configured to align the cutting device within an adapter of a cutting assembly of the power tool.
Aspect 19: A power tool comprising:
   a housing having a top portion, wherein the top portion defines an opening;
   a motor assembly disposed within the housing; and
   a cutting assembly disposed within the housing and coupled to the motor assembly, the cutting assembly comprising a cutting device having a longitudinal axis disposed within the opening, the cutting device comprising:
   a shaft comprising a first end portion and a second end portion oppositely disposed along the longitudinal axis; and
   a cutting portion coupled to the second end portion of the shaft, the cutting portion comprising a cutting surface angularly oriented with respect to the longitudinal axis, the cutting surface configured to engage and cut through a material,
   wherein the motor assembly is configured to drive the cutting device between a first position and a second position in a reciprocating motion to cause the cutting device to engage and cut through the material.
Aspect 20: The power tool according to aspect 19, wherein the angular orientation of the cutting surface is between 10° and 60° with respect to the longitudinal axis.
Aspect 21: The power tool according to aspect 19 and aspect 20, wherein the cutting surface extends outwardly with respect to the longitudinal axis from a first portion of an exterior surface of the cutting portion.
Aspect 22: The power tool according to aspect 21, wherein an angle extending from the cutting surface to the first portion of the exterior surface is between 10° and 60°.
Aspect 23: The power tool according to aspect 21 or aspect 22, wherein the first portion of the exterior surface of the cutting portion extends along the longitudinal axis.
Aspect 24: The power tool according to any of aspects 19-23, wherein the first portion of the exterior surface extends along a plane substantially parallel to the longitudinal axis.
Aspect 25: The power tool according to any of aspects 19-24, wherein the cutting surfaces extends radially outwardly from the first portion of the exterior surface.
Aspect 26: The power tool according to any of aspects 19-25, wherein the cutting surface and the first portion of the exterior surface of the cutting portion define at least a portion of a recess within the cutting portion.
Aspect 27: The power tool according to aspect 26, wherein the cutting surface, the first portion of the exterior surface of the cutting portion, and a second portion of the exterior surface of the cutting portion define the recess, wherein the second portion of the exterior surface of the cutting portion extends outwardly with respect to the longitudinal axis from the first portion of the exterior surface of the cutting portion.
Aspect 28: The power tool according to aspect 27, wherein the first portion of the exterior surface of the cutting portion is contiguous with and positioned between the cutting surface and the second portion of the exterior surface of the cutting portion.
Aspect 29:The power tool according to aspect 27 or aspect 28, wherein the second portion of the exterior surface of the cutting portion extends radially outwardly from the first portion of the exterior surface.
Aspect 30: The power tool according to any of aspects 27-29, wherein the second portion of the exterior surface of the cutting portion is substantially parallel to the cutting surface.
Aspect 31: The power tool according to any of aspects 27-30, wherein an angle extending from the second portion of the exterior surface of the cutting portion to the first portion of the exterior surface is between 100°and 150°.
Aspect 32: The power tool according to any of aspects 27-31, wherein the second portion of the exterior surface of the cutting portion is angularly oriented with respect to the longitudinal axis.
Aspects 33: The power tool according to aspect 32, wherein the angular orientation of the second portion of the exterior surface of the cutting portion is between 100° and 150° with respect to the longitudinal axis
Aspect 34: The power tool according to any of aspects 19-33, wherein the shaft further comprises an indentation positioned between the first end portion and the second end portion, wherein the indentation engages a locking component of the cutting assembly.
Aspect 35: The power tool according to aspect 34, wherein the indentation is positioned closer to the first end portion than the second end portion.
Aspect 36: The power tool according to any of aspects 19-35, wherein the shaft further comprises a notch abutting said first end portion, wherein the notch aligns the cutting device within an adapter of the cutting assembly.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. power tool comprising:
a housing having a top portion defining a work surface, wherein the top portion defines an opening;
a motor assembly disposed within the housing;
a cutting assembly disposed within the housing and coupled to the motor assembly, the cutting assembly comprising a cutting member disposed within the opening, wherein the motor assembly is configured to drive the cutting member in a reciprocating motion; and
a guard surrounding the cutting member, wherein the guard extends into the opening in the top portion and is secured in a fixed position relative to the work surface, the guard comprising a slot configured to receive the material to be cut, wherein a gap between the guard and the work surface is configured to receive the material to be cut while preventing a finger of a user from accessing the cutting member.

2. The power tool according to claim 1, wherein the guard comprises a mark configured to indicate a direction of cutting.

3. The power tool according to claim 1, wherein the gap is no greater than 4 millimeters at any point around the cutting member.

4. The power tool according to claim 3, wherein the gap is between 3 millimeters and 4 millimeters at any point around the cutting member.

5. The power tool according to claim 1, wherein the guard is configured to allow reciprocating motion of the cutting member through the guard.

6. The power tool according to claim 1, wherein the cutting member comprises a rod having a groove configured to engage and cut through the material.

7. The power tool according to claim 1, wherein the guard comprises a key configured to fit into the opening in the top portion.

8. The power tool according to claim 1, wherein the cutting assembly further comprises:
an adapter coupled to the cutting member; and
a cam shaft coupled to the adapter, wherein the cam shaft is configured to convert rotational motion to the reciprocating motion of the cutting member.

9. The power tool according to claim 1, wherein the motor assembly comprises:
a motor;
a drive shaft driven by the motor; and
a belt coupling the drive shaft to the cutting assembly.

10. The power tool according to claim 1, further comprising a debris collection system comprising a drawer slidably received within the housing, the drawer comprising a plurality of side panels and a bottom panel defining a collection space configured to contain debris.

11. The power tool according to claim 10, further comprising a switch or sensor configured to disable the motor assembly when the drawer is removed from the housing.

12. power tool comprising:
a housing having a top portion, wherein the top portion defines an opening;
a motor assembly disposed within the housing;
a cutting assembly disposed within the housing and coupled to the motor assembly, the cutting assembly comprising a cutting device having a longitudinal axis, the cutting device comprising:
a shaft comprising a first end portion and a second end portion oppositely disposed along the longitudinal axis, wherein the first end portion is configured to couple to an adapter of the cutting assembly; and
a cutting portion coupled to the second end portion of the shaft, the cutting portion comprising a cutting surface angularly oriented with respect to the longitudinal axis, the cutting surface and a first portion of an exterior surface of the cutting portion defining at least a portion of a recess within the cutting portion, wherein the first portion of the exterior surface extends parallel or substantially parallel to the longitudinal axis and is contiguous with or immediately adjacent to the cutting surface, the cutting surface configured to engage and cut through a material, the first portion configured to extend through the opening of the housing,
wherein the motor assembly is configured to drive the cutting device in a reciprocating motion.

13. The power tool according to claim 12, wherein the angular orientation of the cutting surface is between 10° and 60° with respect to the longitudinal axis.

14. The power tool according to claim 12, wherein the cutting surface, the first portion of the exterior surface of the cutting portion, and a second portion of the exterior surface of the cutting portion define the recess, wherein the second portion of the exterior surface of the cutting portion extends outwardly with respect to the longitudinal axis from the first portion of the exterior surface of the cutting portion.

15. The power tool according to claim 12, wherein the shaft further comprises an indentation positioned between the first end portion and the second end portion, the indentation configured to engage a locking component of the cutting assembly.

16. The power tool according to claim 12, further comprising a guard surrounding the cutting device, the guard comprising a slot configured to receive the material to be cut while preventing a finger of a user from accessing the cutting device.

17. A kit comprising:
a power tool comprising:
a housing having a top portion, wherein the top portion defines an opening;
a motor assembly disposed within the housing;
a cutting assembly disposed within the housing and coupled to the motor assembly, the cutting assembly comprising a cutting member disposed within the opening, wherein the motor assembly is configured to drive the cutting member in a reciprocating motion; and
a guard surrounding the cutting member, the guard comprising a slot configured to receive a material to be cut while preventing a finger of a user from accessing the cutting member; and
at least one accessory configured for use with the power tool.

18. The kit according to claim 17, wherein the top portion of the housing comprises a lid, the lid comprising a grid design with size markings and defining one or more openings configured to receive the cutting member.

19. The kit according to claim 17, wherein the at least one accessory comprises one or more of:
a straight cutting guide configured to slide along one or more slots in the top portion to guide straight cutting of the material;
a circular cutting guide comprising a plurality of openings configured to fit around the guard, the circular cutting guide comprising at least one pin configured to hold the material at a determined distance from the guard to define a radius of a cut;
an angled cutting guide configured to set an angle for cutting the material; or
a hole punch having a body with an end that tapers to a tip configured to punch a hole in the material, wherein a shape and size of the hole corresponds to the guard to allow the material to be placed on the top portion with the guard extending through the hole.

20. The kit according to claim 17, further comprising an instruction manual of different models to make from the material.
